(19) United States
(12) Patent Application Publication
(10) Pub. No.: US 2015/0356495 A1
(43) Pub. Date: Dec. 10, 2015

(54) DIGITAL WORKSPACE

(71) Applicant: Accenture Global Services Limited, Dublin (IE)

(72) Inventors: Gurdeep Virdi, Bangalore (IN); Alex Kass, Palo Alto, CA (US)

(21) Appl. No.: 14/728,295

(22) Filed: Jun. 2, 2015

(30) Foreign Application Priority Data
Jun. 5, 2014 (IN) 2775/CHE/2014

(51) Int. Cl. G06Q 10/06

(52) U.S. Cl. CPC G06Q 10/063114

(57) ABSTRACT

A digital workspace connects enterprise applications with collaborative applications and social applications into a unified work environment. The digital workspace includes rule-based process mediation service circuitry in communication with the enterprise application and collaboration hub service circuitry in communication with the rule-based process mediation service circuitry and the social application. The digital workspace implements a messaging exchange architecture in support of completion of the workflow within the digital workspace. The messaging exchange includes receiving a workflow status message from the enterprise application, executing a matching task rule with the rule-based process mediation service circuitry responsive to the workflow status message, and in response, issuing a collaboration message to the collaboration application, issuing an information message to the social application, or both.

### PRIORITY CLAIM

This application claims the benefit of priority of Indian provisional application serial number 2775/CHE/2014, filed 5 Jun. 2014, and the corresponding Indian non-provisional application serial number 2775/CHE/2014, filed 21 May 2015.

### TECHNICAL FIELD

This disclosure relates to a digital collaboration system including a rule-based processing engine and communication architecture that facilitates completion of complex tasks and information exchange among task stakeholders.

### BACKGROUND

Rapid advances in sophisticated software tools (e.g., business process management (BPM) tools) have changed the fundamental way that organizations accomplish their workflows. At the same time, the number of stakeholders involved in the workflows has increased dramatically, along with the number and type of social and collaboration tools by which the stakeholders communicate. Improvements around these tools will help businesses continue to meet their increasingly sophisticated workflow goals as they become more complex and as more stakeholders become involved with the workflows.

### BRIEF DESCRIPTION OF THE DRAWINGS

FIG. 1 shows an example of an example system for implementing a digital workspace.

FIG. 2 shows example connectivity for a digital workspace.

FIG. 3 shows an example of a digital workspace.

FIG. 4 shows an example of a digital workspace for insurance underwriting.

FIG. 5 shows a GUI for an enterprise application in a digital workspace.

FIG. 6 shows digital workspace messages.

FIG. 7 shows a GUI for an enterprise application in a digital workspace.

FIG. 8 shows a flow diagram of logic that a system may implement to provide a digital workspace.

FIG. 9 shows a system architecture connected with a digital workspace.

### DETAILED DESCRIPTION

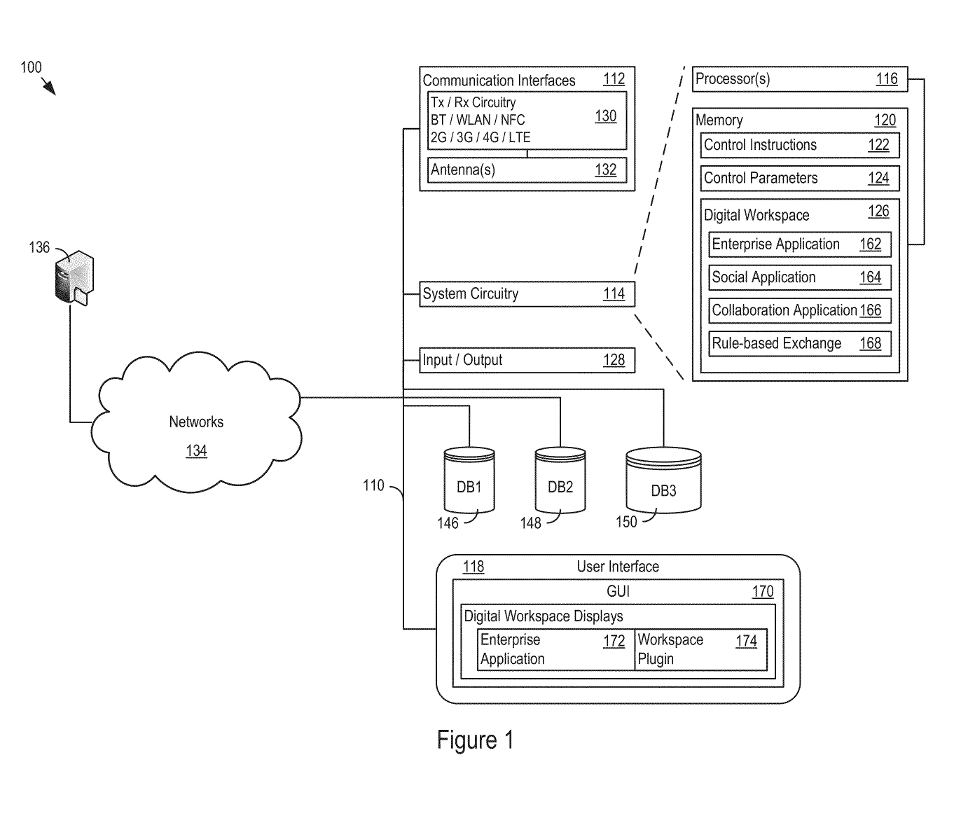

FIG. 1 shows an example of a system 100. The system 100 may be implemented in a desktop computer running, e.g., a Microsoft™ Windows™ operating system or Macintosh™ OS), laptop computer, tablet computer, or smartphone, as just a few examples. The techniques described below regarding implementing a digital workspace may be implemented in a wide array of different types of devices. Accordingly, the system example described below provides just one example context for explaining the digital workspace techniques.

The system 100 includes communication interfaces 112, system circuitry 114, and a user interface 118. The system circuitry 114 may include any combination of hardware, software, firmware, or other circuitry. The system circuitry 114 may be implemented, for example, with one or more systems on a chip (SoC), application specific integrated circuits (ASIC), discrete analog and digital circuits, and other circuitry.

The system circuitry 114 is part of the implementation of any desired functionality in the system 100, such as providing a digital workspace. The system circuitry 114 may, as just a few examples, run applications, accept user inputs, save and retrieve application data, exchange messages between applications, the user, and the display, and display information on the user interface 118.

The user interface 118 and the input/output interfaces 128 may include a graphical user interface (GUI), touch sensitive display, voice or facial recognition inputs, buttons, switches, speakers and other user interface elements. Additional examples of the inputs 128 include microphones, video and still image cameras, headset and microphone input/output jacks, Universal Serial Bus (USB) connectors, memory card slots, and other types of inputs. The input/output interfaces 128 may further include Universal Serial Bus (USB) interfaces, audio outputs, magnetic or optical media interfaces (e.g., a CDROM or DVD drive), network (e.g., Ethernet or cable (e.g., DOCSIS) interfaces), or other types of serial, parallel, or network data interfaces.

The communication interfaces 112 may connect the system 100 to other systems. For instance, the system 100 may receive workflow inputs through the networks 134 (including, e.g., Internet connections) from many different sources, such as remote systems 136. That is, stakeholders using the remote systems 136 may interact with enterprise software or other applications running locally or in the system 100. The system 100 may implement a digital workspace to facilitate completion of the workflow.

The system 100 may access databases either locally or remotely (e.g., over the networks 134). The databases may include, as examples, metadata databases 146 for tagging messages and other information communicated by the system 100 between applications, stakeholder databases 148 that define or identify stakeholders for applications and workflows, databases 150 that identify the collaboration applications, social applications, and enterprise applications that the system may join into a digital workspace, or other databases.

The system circuitry 114 may include one or more processors 116 and memories 120. The memory 120 stores, for example, control instructions 122 that the processor 116 executes to carry out desired functionality for the system 100. The control instructions 122 operate with parameters specified by the control parameters 124. The control instructions 122 may create a digital workspace 126 that connects enterprise applications 162 (e.g., BPM applications), social applications 164 (e.g., Facebook™ or Twitter™ or Jive™ applications), and collaboration applications 166 (e.g., SharePoint). The digital workspace 126 may connect the applications with a rule-based exchange 168, e.g., as described further below.

FIG. 1 shows that the control instructions 122 may render, e.g., on the GUI 170, a representation of the digital workspace. For instance, the representation may include the enterprise application window 172 for accomplishing a workflow (e.g., a BPM application) and a digital workspace plugin 174 associated with (e.g., within or adjacent to) the enterprise application window 172. As specific examples, the digital workspace plugin 174 may be displayed or presented to a user as a window within a slideshow presentation development program (e.g., Microsoft PowerPoint), or as a message pop-up window adjacent to an insurance underwriting enterprise application window. The digital workspace plugin 174 provides a communication hub through which the digital workspace 126 reacts to completion of workflow tasks in the enterprise application, and communicates messages to provide collaboration in support of workflow completion or status updates (e.g., informational messages) in support of workflow completion.

In some implementations, the control instructions 122 implement the digital workspace 126 by identifying an enterprise application executing to support completion of a workflow, e.g., a BPM application, identifying stakeholders in the workflow, identifying a collaboration application through which the stakeholders interact to support the completion of the workflow, and identifying a social application through which the stakeholders receive messages in support of the completion of the workflow. The control instructions 122 then create a digital workspace in which rule-based process mediation service circuitry is in communication with the enterprise application and collaboration hub service circuitry is in communication with the rule-based process mediation service circuitry and the social application. The control instructions 122 execute executing messaging exchange in support of completion of the workflow for the digital workspace 126, including receiving a task completion (or other status update) message from the enterprise application 162, executing a matching task rule with the rule-based process mediation service circuitry responsive to the task completion message, and in response, issuing a collaboration message to the collaboration application 166, issuing an information message to the social application 164, or both.

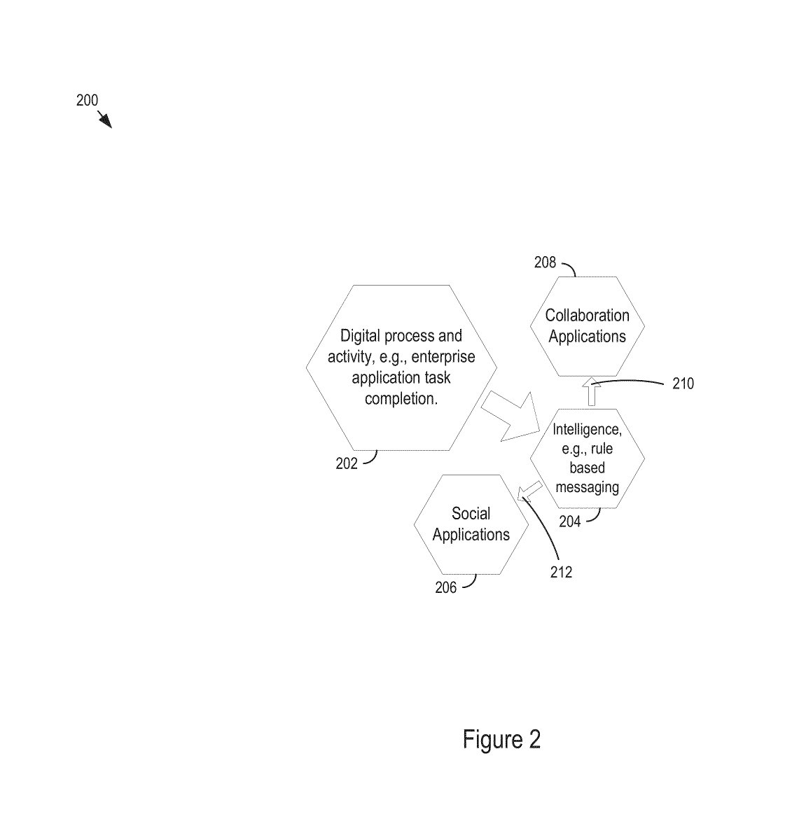

FIG. 2 shows example connectivity 200 that the digital workspace 126 may implement. The connectivity 200 includes enterprise applications 202 communicating to an intelligence engine 204. The enterprise applications 202 may send, as examples, task completion messages, status update messages, or any other messages that relate to the progress of the workflow within the enterprise application 202. The intelligence engine 204 may be a rule-based process mediation service. For instance, the intelligence engine 204 may define rules or obtain rules from any source, evaluate the rules, and determine when the rules should fire, e.g., responsive to the input received from the enterprise applications 202.

The rules may determine whether and when messages are issued by the intelligence engine 204 to other applications, and the content of the messages. For instance, the intelligence engine 204 may issue collaboration messages 210 to the collaboration applications 208, and issue information messages 212 to the social applications 206. The collaboration messages may specify, for instance, a desired collaboration action between stakeholders in support of completion of the workflow (e.g., to meet and discuss an action item, or to provide edits on a draft, or to approve a proposed revision). As further examples, the collaboration messages may provide an active link to start a real-time dialogue between the stakeholders. Information messages may be presented through the digital workspace plugin 174 as a notification to the user completing the workflow within the enterprise application 202. For example, the notification message may alert the user of information relevant to an intermediate step of the workflow. Information and collaboration messages may be triggered, for example, by rules that identify keywords or other types of input made by the user during completion of steps of the workflow.

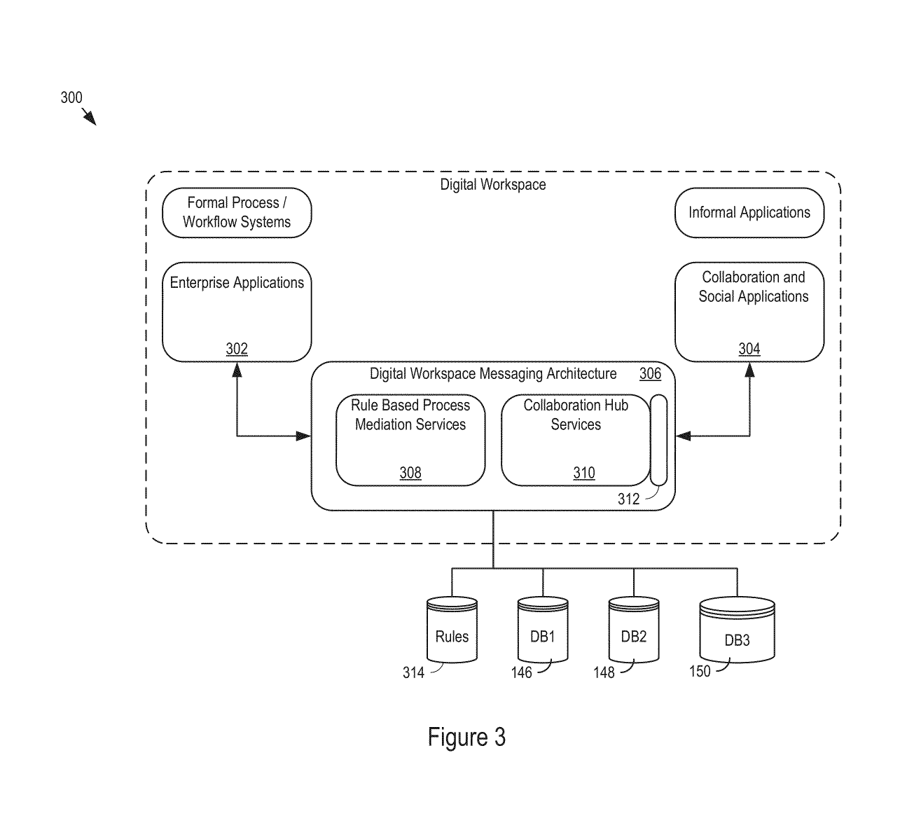

FIG. 3 shows an example of a digital workspace 300. The digital workspace 300 connects formal workflow systems 302 with collaboration and social applications 304 through a digital workspace messaging architecture 306. The digital workspace messaging architecture 306 (“messaging architecture 306”) is one implementation example of the intelligence engine 204. Within the messaging architecture 306 is rule-based service circuitry 308 (“service circuitry 380”) and collaboration hub service circuitry 310. The rule-based service circuitry 308 may receive a task completion message, workflow status message, or any other status update message from the enterprise applications 302, search a rule database 314 for a task rule that matches against the information provided by the message, find a matching task rule, execute the rule, and in response issue messages or take other action. The messages may include collaboration and information messages to the collaboration and social applications 304. In addition, the service circuitry 308 may direct the collaboration hub service circuitry 310 to communicate specific messages to the collaboration and social applications 304. The interface adaptors 312 may convert messages in the messaging architecture 306 to a form or into content suitable for any particular collaboration and/or social application 304.

In more detail, the service circuitry 308 may include a set of services which interact with the formal workflow systems 302. The service circuitry 308 may perform abstraction of the process information, set up the process rules which govern the collaboration actions in support of executing the workflow, determine the context of a particular/current process step in the workflow, form a status message to post to the social application or collaboration application, and identify stakeholders for the workflow, e.g., by querying the enterprise application 302, a human resources database, or another source of stakeholder information.

The collaboration hub service circuitry 310 may include a set of services that interact with the social applications 304. The circuitry 310 may abstract the collaboration information, identify relevant stakeholders within any collaboration or social application, form an information feed based on the context provided, post messages to the relevant groups and stakeholders, tag the messages with descriptive metadata, convert actions within any given social or collaboration application into status messages or updates within the enterprise application, or parse process mediation services generated messages (e.g., determine which rules to apply, if any) to update informal application components.

The digital workspace 300 facilitates collaboration among stakeholders in a workflow. With regard to formal process and workflow setup, the system 100 may automatically create the digital collaboration workspace (e.g., using SharePoint or Chatter) for coordination and information exchange when a workflow or process is initiated in an enterprise application (e.g., the Pega BPM application), assist in identification of relevant stakeholders using information from the enterprise application, and assist in identification of relevant documents and knowledge in various forms.

Upon process or workflow execution, the digital workspace may help reduce noise by posting comments to relevant identified stakeholders, provide a contextual and content rich information feed displayed and updated real time (e.g., in the workspace plugin 174) as workflow progresses in the enterprise application, and provide automated and actionable forming of comments for status updates to various stakeholders, e.g., through the collaboration and social applications, and take rule-based collaboration actions based on activity in the enterprise application. Content provided in the information feed may include text, video, static images, hyperlinks, or any other type of content.

Regarding coordination and information exchange, the digital workspace may: automatically post to the information feed activities within other applications, such as collaboration and social applications Chatter and SharePoint, which appears as part of the workflow; update formal process/workflow systems based on actions within collaboration and social applications; and tag with descriptive metadata comments posted, e.g., in collaboration and social applications and add the tagged comments into a knowledge database.

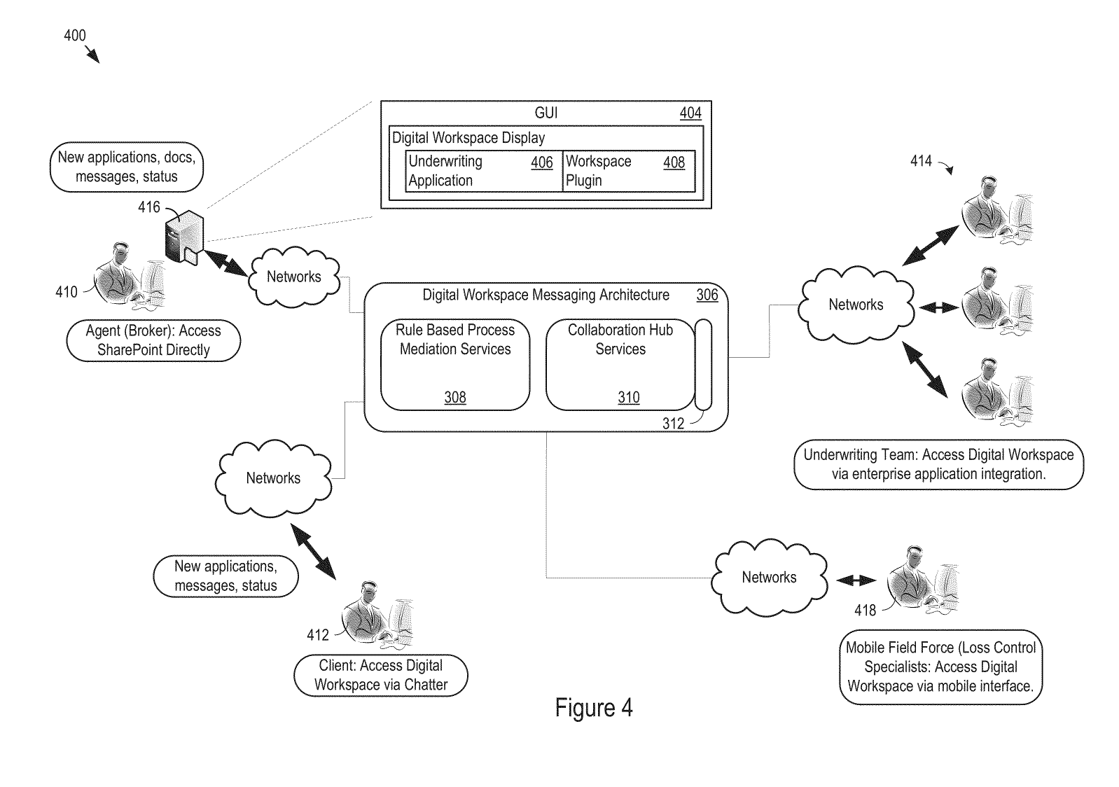

FIG. 4 shows a digital workspace 400 in which multiple entities collaborate through a digital workspace messaging architecture 306 to accomplish insurance underwriting. In this example, the messaging architecture 306 connects various stakeholders by providing collaboration messages to a workspace plugin 408 for an underwriting application display window 406. An enterprise application server 416 executes the underwriting application itself, and may be physically or logically present at any location.

The workspace plugin 408 facilitates communication between the enterprise application and the social and collaboration applications, for example, by displaying information messages in the workspace plugin 408 to prompt collaboration or other actions by stakeholders. In the example, the agent 410 is an insurance broker using an underwriting enterprise application to prepare a new insurance policy for a client 412. The underwriting application communicates with the message exchange architecture 306 regarding, e.g., new insurance policy applications, workflow status (e.g., current workflow step, errors to resolve, and agent questions on the workflow).

The client 412 may communicate with the agent 410 by sending messages from a local messaging client (e.g., a Chatter client) to the workspace plugin 408 directly, or through the messaging architecture 306. The underwriting team 414 communicates with the agent 410 through the messaging architecture 306 as well, e.g., via an integration module configured in their local enterprise application (e.g., an instance of the underwriting application executed by the agent, or a separate underwriting support application), to provide and exchange, e.g., underwriting information and complete underwriting workflows. FIG. 4 also shows mobile field force control personnel 418 in communication with the messaging architecture 306 using a mobile interface, e.g., a wireless 3G/4G/LTE data interface, WiFi, or other mobile interface.

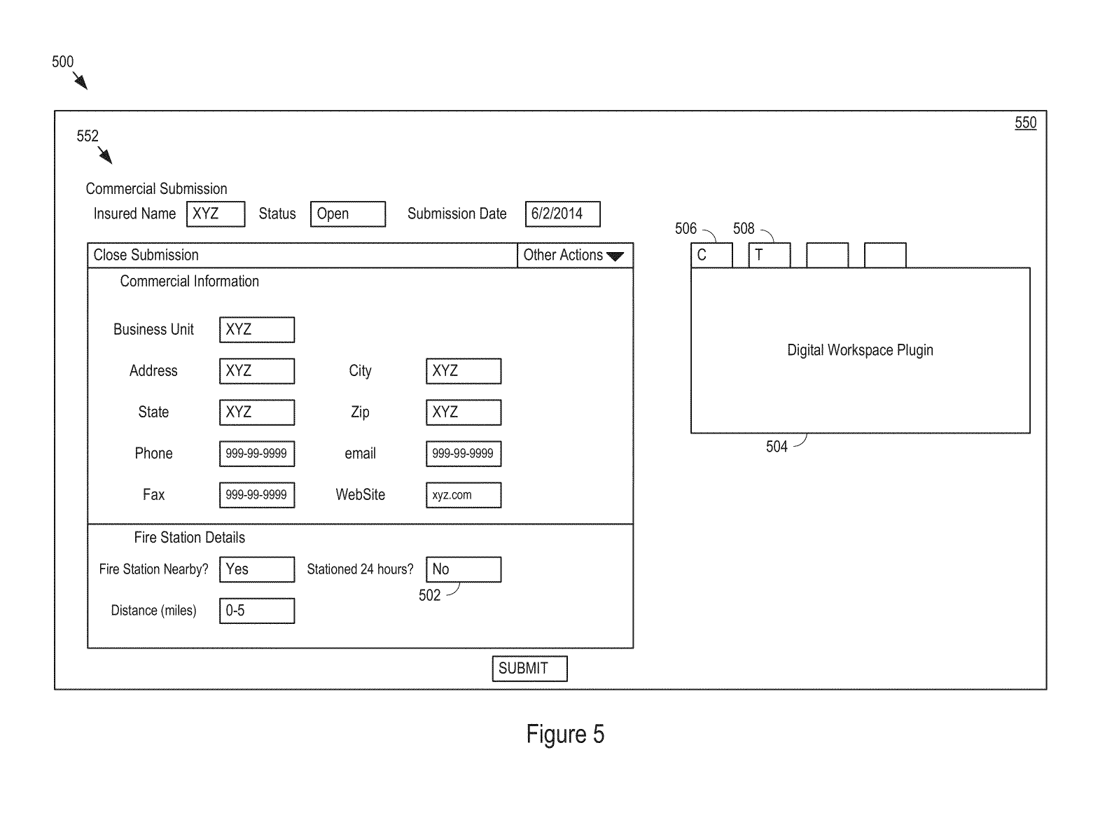

FIG. 5 shows a GUI 500 for an enterprise application in a digital workspace. In this example, an insurance underwriting workflow is underway, e.g., by the agent 410. The underwriting application generates the underwriting application window 550, including the underwriting GUI elements 552 and the digital workspace plugin 504. The digital workspace plugin 504 exchanges messages with the messaging architecture 306.

In FIG. 5, the underwriter has completed the fire station information, noting with the GUI element 502 that the station is not stationed 24 hours a day. The completion of the fire station information causes the enterprise underwriting application to send a status message to the messaging architecture 306. In the messaging architecture 306, the rules-based processing circuitry 308 determines that a matching rule exists (e.g., a rule that is relevant to entering the fire station information). In this example, the rule specifies notification of a supervisor in the underwriting team 414 through a message to a social application used by the supervisor to request verification of the lack of 24 hour stationing at the fire station. In response, the messaging architecture 306 executes the rule and the digital workspace plugin 504 (integrated into the enterprise insurance application) displays the verification request message sent to the supervisor in the underwriting team 414 and any responses received from the supervisor via the messaging architecture 306.

In this regard, the messaging architecture 306 may send the verification message to a specific collaboration or social application associated with the supervisor. The supervisor receives the request to verify the 24 hour status, and sends a response. The messaging architecture 306 directs the response back to the digital workspace plugin 504. Note that the workspace plugin 504 may organize messages by type, and allow a user to view the messages received by selecting an application tab, such as tab 506 to view Chatter messages, or tab 508 to view Twitter messages.

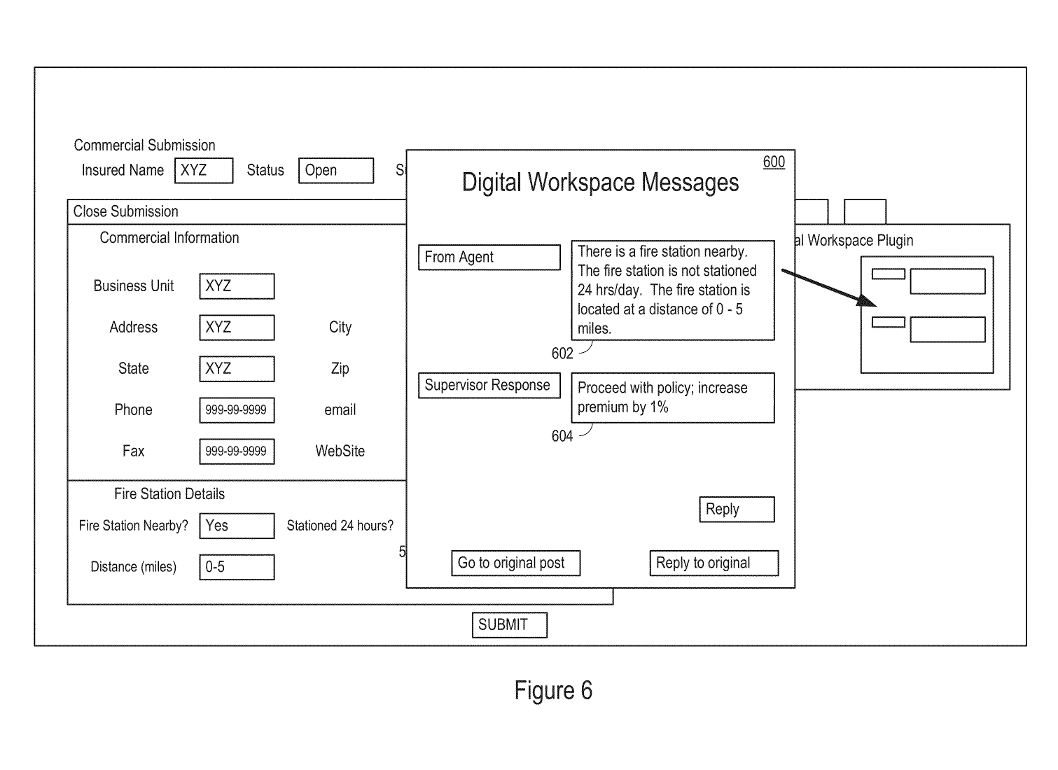

FIG. 6 shows digital workspace messages 600 for verifying the fire station information. The messaging architecture 306 exchanged the messages 600, e.g., as automatic entries into the activity feed displayed in the digital workspace plugin 504 for the workflow. The messages 600 show the notification message 602 generated by executing a matching rule at the messaging architecture 306. The messaging architecture 306 sends the notification message 602 to the supervisor regarding the issue. The messaging architecture 306 also receives the response message 604 from the supervisor and sends it to the digital workspace plugin 504 for the agent to review.

In this manner, the messaging architecture 306 automatically alerts identified stakeholders (e.g., the supervisor in the underwriting team 414) that an agent has indicated, in their new policy workflow application, a lack of 24 hours service at the fire station. In response, the supervisor may provide a response, such as specifying whether to proceed with the policy, or by how much to increase the policy premium.

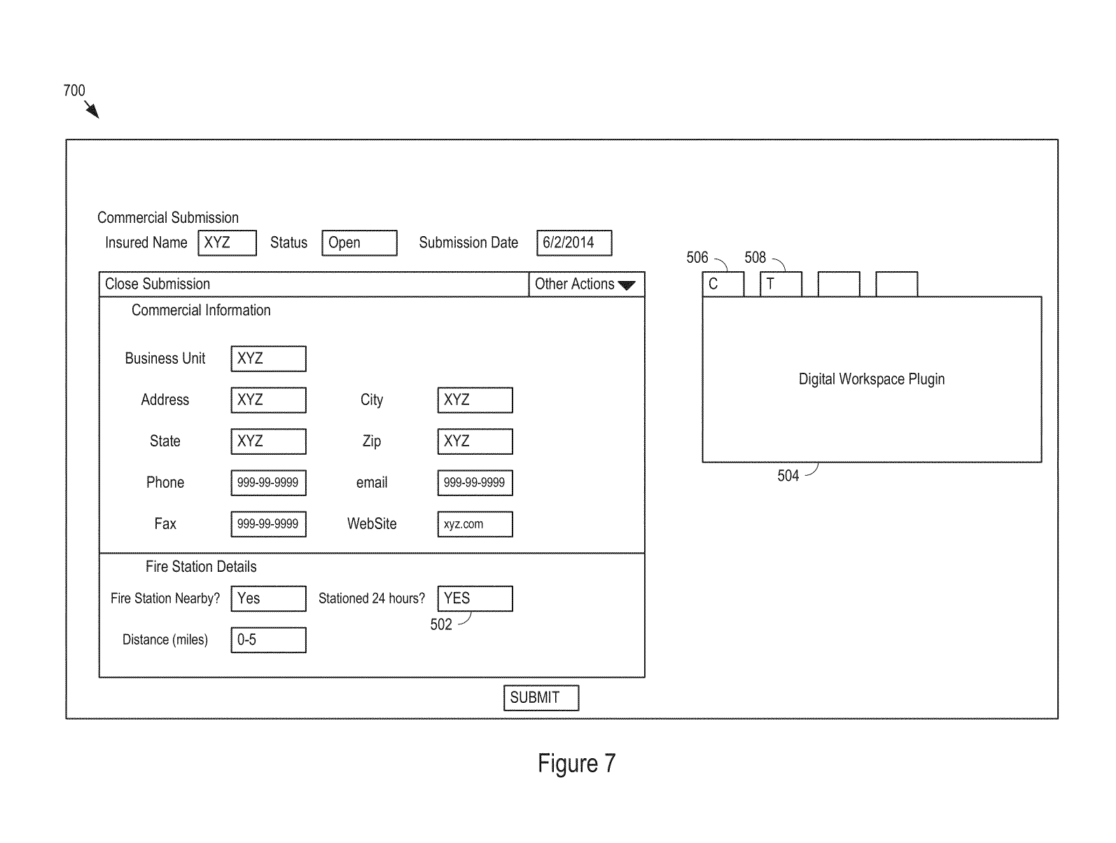

Any other types of exchanges may take place as well. For instance, the agent 410 may reply to clarify the reason for the initial setting for the fire station, and provide documentation into the enterprise workflow system. The documentation may take the form of audio or video files, text documents, digital photographs, or other files. The messaging architecture 306 may store the files in any specified collaboration application, e.g., in a SharePoint database or a Document Management System (DMS). For example, the agent 410 may respond that, e.g., “There is a new fire station nearby, and it is 24 hrs. The national database of fire-stations is not updated yet. I will send you a letter from the county confirming.” As shown in FIG. 7, the supervisor may receive the message and a link to the documentation in the collaboration application via the messaging architecture 306, view the agent response and documentation, determine to accept the explanation, and then respond that the agent is authorized to update the fire station status to 24 hrs. In other implementations, e.g., where the supervisor runs an instance of the new policy underwriting application, and has access to the new policy workflow executed by the agent 410, the supervisor may directly change the status of the GUI element 502 upon accepting the explanation. The system thereby facilitates the completion and correction of the workflow, without the need for lengthy out of band communications or negotiations.

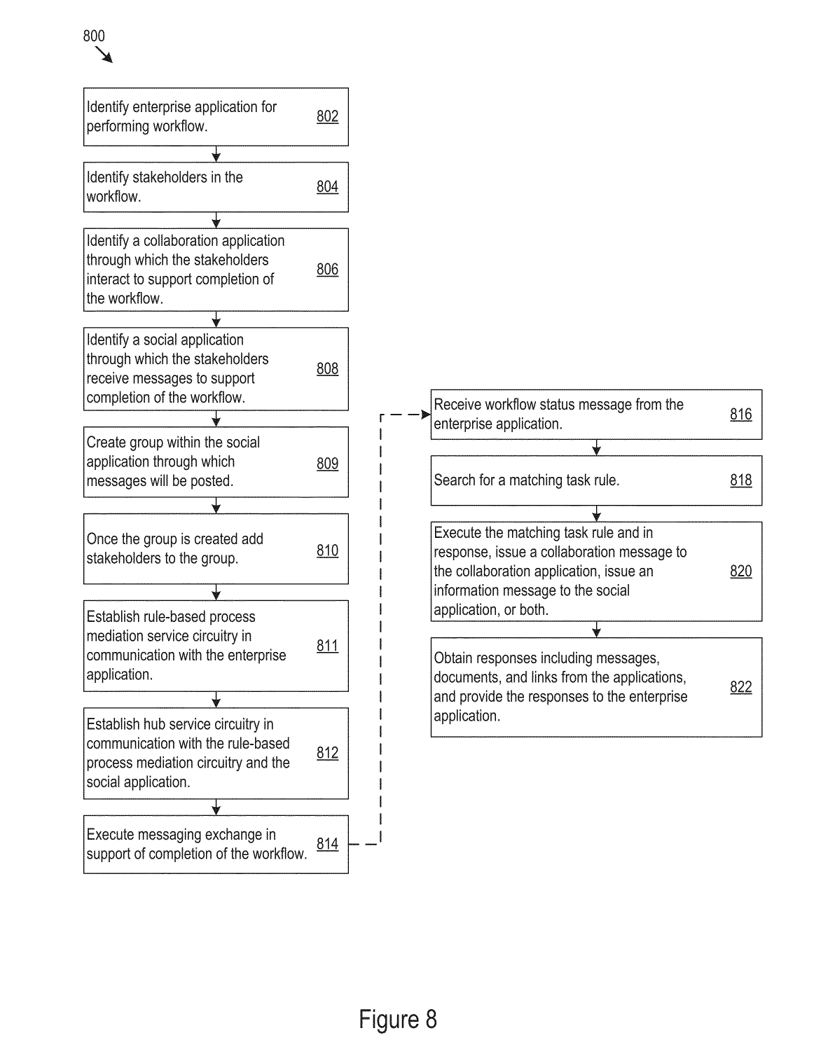

FIG. 8 shows a flow diagram one example of logic 800 that a system may implement to provide a digital workspace. The logic identifies an enterprise application executing to support completion of a workflow (e.g., Pega BPM) (802), and identifying stakeholders in the workflow (804), e.g., by querying the enterprise application, by querying a database of stakeholders by enterprise application, by searching documentation files that list stakeholder names for the enterprise applications, or in other manners. The logic 800 also identifies (e.g., by querying the stakeholder database) a collaboration application through which the stakeholders interact to support the completion of the workflow (806), and identifies a social application through which the stakeholders receive messages in support of the completion of the workflow (808).

The logic 800 may create a group within the social application where messages may be posted (809). Once the group is created, the logic 800 may add the identified stakeholders to the group (810). For example, stakeholders identified using the resources discussed above. In some cases, once the task is completed the groups may be disbanded, deleted or otherwise cease to exist. For example, the logic 800 may set the group to expire once the duration of the task has expired. The group may be used to exchange messages during the task.

The logic 800 also establishes the rule-based process mediation service circuitry 308 in communication with the enterprise application (811). In one implementation, the service circuitry 308 includes a processor 116 executing control instructions 122 that exchange messages between enterprise applications, collaboration applications, and social applications. The implementation may also receive, e.g., workflow status messages, search a rule database 314 for applicable rules, and execute the rules to facilitate collaboration among stakeholders. The logic 800 also establishes collaboration hub service circuitry 310 in communication with the rule-based process mediation circuitry 308 and the enterprise, collaboration, and social applications (812). In some implementations, the collaboration hub services circuitry 310 may also use the processor 116 to execute control instructions that exchange messages between the social applications, interact with collaboration applications (e.g., to store and retrieve documents), and to direct messages between the enterprise applications, collaboration applications, and the social applications as directed by the rules processed by the mediation service circuitry 308. As noted above, the collaboration hub services circuitry 310 may direct messages through the interface adaptors 312 to meet the message format and content specified by the applications.

The logic 800 executes messaging exchange in support of completion of the workflow (814). In that regard, the logic 800 may receive a workflow status message, e.g., a task completion message, from an enterprise application (816) and search for a matching task rule (818) based on any of the information in the workflow status message. The logic 800 may also execute the matching task rule(s) and take any specified actions in response. For instance, the logic 800 may issue a collaboration message to the collaboration application, store or retrieve a document using the collaboration application, issue an information message to the social application, or take any other action or combination of actions. Messages and documents may flow in both directions between the applications, and thus the logic 800 may also obtain responses including messages, documents, and links from the applications, and provide the responses to the enterprise application (822).

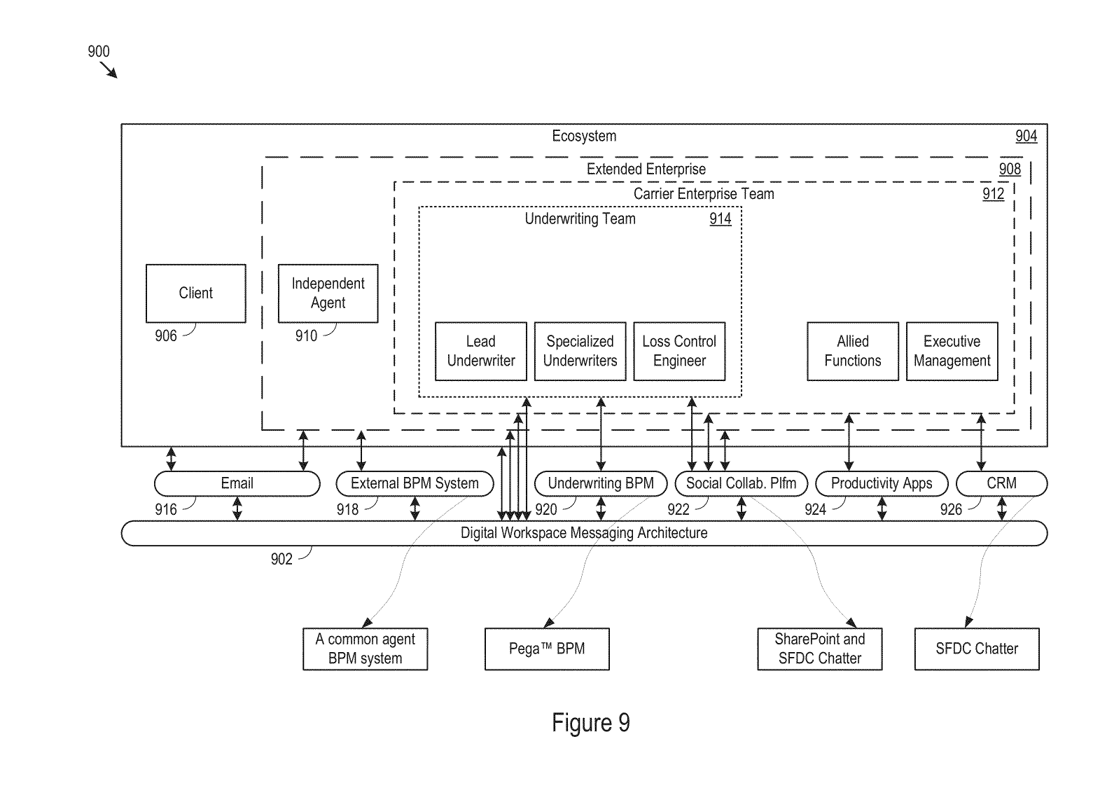

FIG. 9 shows a system architecture 900 connected with a digital workspace for an insurance enterprise application. The digital workspace messaging architecture 902 (see, e.g., FIGS. 1 and 3, element 306) connects applications within a workflow ecosystem 904 encompassing entity and applications internal and external to a particular company. The ecosystem 904 includes external clients 906 with respect to the particular company, an extended enterprise 908 including independent agents 910, the specific carrier enterprise team 912, and an underwriting team 914.

FIG. 9 shows how the digital workspace messaging architecture 902 connects multiple different applications into the insurance workflow. The applications include email 916 (e.g., a social application and collaboration application), an external BPM system 918 (e.g., a common agent BPM system), and the enterprise underwriting BPM application 920 (e.g., the Pega™ BPM system). The applications further include social collaboration platforms 922 (e.g., Facebook™, Twitter™, SharePoint™, and Chatter™ platforms), productivity applications (e.g., Visio and Word), and Customer Resource Management (CRM) applications 926 (e.g., including SFDC Chatter).

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Various implementations have been specifically described. However, many other implementations are also possible.

What is claimed is:

1. A method comprising:
identifying an enterprise application executing to support completion of a workflow;
identifying stakeholders in the workflow;
identifying a collaboration application through which the stakeholders interact to support the completion of the workflow;
identifying a social application through which the stakeholders receive messages in support of the completion of the workflow; and
creating a messaging architecture comprising:
rule-based process mediation service circuitry in communication with the enterprise application; and
collaboration hub service circuitry in communication with the rule-based process mediation service circuitry and the social application; and
executing a messaging exchange in support of completion of the workflow for the messaging architecture, where executing includes:
receiving a workflow status message from the enterprise application; and
executing a matching task rule for the workflow status message, with the rule-based process mediation service circuitry, responsive to the workflow message, including issuing a collaboration message to the collaboration application, issuing an information message to the social application, or both.

2. The method of claim 1, further comprising:
defining task rules for execution by the rule-based process mediation service circuitry, including the matching task rule.

3. The method of claim 1, further comprising:
identifying the stakeholders by determining that they are associated with the workflow and the enterprise application.

4. The method of claim 3, where determining comprises:
receiving an identification of the stakeholders from the enterprise application.

5. The method of claim 1, further comprising:
issuing a request from the rule-based process mediation service circuitry to the collaboration hub service circuitry to issue the information message to the social application.

6. The method of claim 1, where the workflow status message specifies completion of a portion of the workflow.

7. The method of claim 6, further comprising:
determining a context for the portion of the workflow; and
creating the information message to capture the context of the workflow.

8. The method of claim 1, further comprising:
creating a workflow feed regarding workflow status of the workflow; and
delivering the workflow feed to the social application.

9. The method of claim 1, further comprising:
tagging the collaboration message, the information message, or both with content descriptive metadata tags.

10. The method of claim 1, further comprising:
receiving a response message from the social application; and
sending the response message to an enterprise plugin of the enterprise application.

11. A system comprising:
a rule database configured to specify a workflow rule for an enterprise application;
a stakeholder database configured to specify a stakeholder for the enterprise application and a social application for the stakeholder;
rule-based process mediation service circuitry in communication with the enterprise application; and
messaging circuitry configured to:
receive a workflow status message from the enterprise application;
determine that the workflow rule matches the workflow status message;
execute the workflow rule responsive to the workflow status message by sending an information message to the social application for the stakeholder;
receive a response message to the information message from the stakeholder; and
direct the response message to a workspace plugin of the enterprise application.

12. The system of claim 11, where the messaging circuitry comprises:
rule-based process mediation service circuitry in communication with the enterprise application.

13. The system of claim 12, where the messaging circuitry comprises:
collaboration hub service circuitry in communication with the rule-based process mediation service circuitry and the social application.

14. The system of claim 11, where the messaging circuitry is further configured to:
identify a collaboration application for the stakeholder;
receive a document file from the enterprise application; and
submit the documentation file to the collaboration application.

15. The system of claim 14, where the messaging circuitry is further configured to:
generate a link to the documentation file; and
include the link in the information message.

16. The system of claim 11, where the messaging circuitry further comprises:
a messaging adaptor configured to convert the information message into a form compatible with the social application.

17. The system of claim 11, where the messaging circuitry is further configured to:
tag the response message, the information message, or both with a metadata tag.

18. The system of claim 11, where the messaging circuitry is further configured to:
identify a collaboration application;
receive a document file from the stakeholder;
submit the documentation file to the collaboration application;
generate a link to the documentation file; and
send the link with the response message.

19. A system comprising:
a communication interface;
a rule database configured to specify a workflow rule for an enterprise application hosted on an enterprise server;
a stakeholder database configured to specify:
a stakeholder for the enterprise application;
a social application for the stakeholder; and
a collaboration application for the stakeholder;
messaging circuitry in communication, through the communication interface, with:
a workspace plugin for the enterprise application on the enterprise server;
the social application; and
the collaboration application;
the messaging circuitry comprising:
rule-based process mediation service circuitry configured to:
receive, from the enterprise application, a workflow status message specifying a workflow status of the enterprise application;
receive, from the enterprise application, a workflow status document for the workflow status;
determine that the workflow rule should execute responsive to the workflow status message;
execute the workflow rule responsive to the workflow status message to determine that the stakeholder should receive a notification message regarding the workflow status; and
collaboration hub service circuitry in communication with the rule-based process mediation service circuitry and configured to:
submit the workflow status document to the collaboration application;
generate a document link to the workflow status document;
generate an information message for the stakeholder, the information message comprising:
message content specified by the workflow rule; and
the document link;
send the information message to the social application for the stakeholder;
receive a response message from the stakeholder; and
send the response message from the stakeholder to the workspace plugin.

20. The system of claim 19, where the collaboration hub service circuitry is further configured to:
receive a workflow response file from the stakeholder;
submit the workflow response file to the collaboration application;
generate a workflow response document link to the workflow response file; and
send the workflow response document link with the response message.
